(19) United States
(12) Patent Application Publication
(10) Pub. No.: US 2013/0320944 A1
(43) Pub. Date: Dec. 5, 2013

(54) VOLTAGE REGULATOR, AMPLIFICATION CIRCUIT, AND COMPENSATION CIRCUIT

(71) Applicant: Yuan-Long SIAO, Kaohsiung City (TW)

(72) Inventor: Yuan-Long SIAO, Kaohsiung City (TW)

(73) Assignee: TAIWAN SEMICONDUCTOR MANUFACTURING COMPANY, LTD., Hsinchu (TW)

(21) Appl. No.: 13/488,201

(22) Filed: Jun. 4, 2012

(51) Int. Cl. G05F 1/10

(52) U.S. Cl. 323/282

(57) ABSTRACT

An amplification circuit includes a first amplifier, a second amplifier, and a power supply rejection ratio (PSRR) boost circuit. The first amplifier has an output. The second amplifier has an input coupled to the output of the first amplifier and a power node coupled to a power supply line. The PSRR boost circuit is coupled between the input of the second amplifier and the power supply line, and the PSRR boost circuit comprises a resistance device and a capacitance device connected in series with the resistance device.

### BACKGROUND

An amplification circuit amplifies one or more input signals and has applications in electrical circuits. For example, an amplification circuit, with a suitable feedback path, is usable as a voltage regulator. A voltage regulator outputs a direct current (“DC”) or a quasi DC voltage signal in response to a received reference voltage signal. In many applications, voltage regulators and amplification circuits have adequate phase margin characteristics but usually at the expense of sacrificing power supply rejection ratio (“PSRR”) performance. A PSRR is used to evaluate a circuit's capability of suppressing the noises from a power supply of the circuit by measuring an attenuation ratio between signals at an output of the circuit to that at the power supply.

### BRIEF DESCRIPTION OF THE FIGURES

One or more embodiments are illustrated by way of example, and not by limitation, in the figures of the accompanying drawings, wherein elements having the same reference numeral designations represent like elements throughout and wherein:

FIG. 1 is a block diagram of a voltage regulator in accordance with one or more embodiments;

FIGS. 2 and 3 are circuit diagrams of various examples of the voltage regulator depicted in FIG. 1 in accordance with one or more embodiments;

FIG. 4 is a block diagram of an amplification circuit in accordance with one or more embodiments; and

FIG. 5 is flowchart of a method of operating an amplification circuit or a voltage regulator in accordance with one or more embodiments.

### DETAILED DESCRIPTION

It is understood that the following disclosure provides one or more different embodiments, or examples, for implementing different features of the disclosure. Specific examples of components and arrangements are described below to simplify the present disclosure. These are, of course, examples and are not intended to be limiting. In accordance with the standard practice in the industry, various features in the drawings are not drawn to scale and are used for illustration purposes only.

In various embodiments, the voltage regulators and/or amplification circuits described herein, by using a compensation/PSRR boost circuit, improve a power supply rejection ratio (“PSRR”) and phase margin and thus have better immunity from power supply noise, compared with configurations lacking the compensation/PSRR boost circuit described herein.

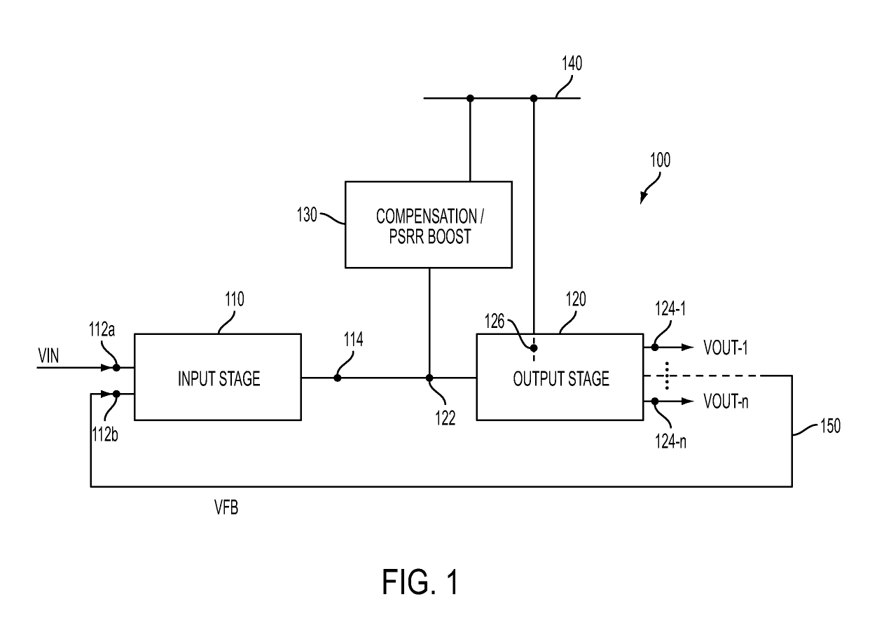

FIG. 1 is a block diagram of a voltage regulator 100 in accordance with one or more embodiments. Voltage regulator 100 includes an input stage circuit 110, an output stage circuit 120, a compensation circuit 130, a power supply line 140, and a feedback path 150 coupling the output stage circuit and the input stage circuit. The input stage circuit 110 has a first input 112a, a second input 112b, and an output 114. The output stage circuit 120 has an input 122 and one or more outputs 124-1˜124-n for outputting one or more corresponding output signals VOUT-1˜VOUT-n, where n is a positive integer. The first input 112a of the input stage circuit 110 is configured to receive an input signal VIN, and the second input 112b of the input stage circuit is configured to receive a feedback signal VFB from the output stage circuit 120. In some embodiments, the input signal VIN is a reference voltage signal. In some embodiments, the reference voltage signal VIN is generated by a band-gap circuit and has a voltage level that is temperature-invariant within a predetermined operation temperature range, such as from −50° C. to +150° C.

The input 122 of the output stage circuit 120 is coupled to the output 114 of the input stage circuit 110. The output stage circuit 120 also has a power node 126 coupled to the power supply line 140, which is in turn coupled to a power supply providing a supply voltage, such as a positive power supply voltage VDD. At least one of the one or more outputs 124-1˜124-n of the output stage circuit 120 is coupled to the second input 112b of the input stage circuit 110 through feedback path 150.

The compensation circuit 130 is coupled between the input 122 of the output stage circuit 120 and the power supply line 140 or between the output 114 of the input stage circuit 110 and the power supply line 140. In some embodiments, the compensation circuit 130 is configured to improve a PSRR of the output stage circuit 120, compared with a configuration where the compensation circuit 130 is omitted.

In some applications, the voltage regulator 100 is used in an integrated circuit (IC) chip that is highly integrated and used in a mobile device. The voltage level at the power supply line 140 tends to be affected by the operation of other electrical components in the IC chip and the stability of a power source of the mobile device. Therefore, in some embodiments, the power supply line 140 is “noisy” compared with other applications, and reduction of power supply line 140 noise impact to the output signals VOUT-1˜VOUT-n is preferred. Also, the power supply line 140 usually has a large parasitic capacitance due to the large area occupied by the power supply line 140, the noise on the power supply line 140 tends to be within a frequency band of 0˜10 kHz. In some embodiments, the compensation circuit 130 causes the PSRR of the output stage circuit 120 to be equal to or greater than 80 dB (i.e., having an attenuation ratio of 1/10,000 measured from one of the outputs 124-1˜124-n to the power supply line 140) within a predetermined frequency band, such as 0˜10 kHz.

In addition, a phase margin is a characteristic used to evaluate stability of a circuit. For performing frequency response and stability analysis of the circuit, in some embodiments, a transfer function in the frequency domain is derived from performing a Laplace transform of the circuit. Thus, the derived transfer function is a behavior model representing the circuit in the frequency domain. The phase margin is the phase difference between the phase of the transfer function at a unit gain frequency and −180 degrees. The greater the phase margin, the more stable the circuit. In many applications, a transfer function with a phase margin greater than 45 degrees has overshooting in a step response curve, and a transfer function with a phase margin greater than 30 degrees has ripples in a step response curve.

In some embodiments, the compensation circuit 130 is configured to improve a phase margin of the overall voltage regulator circuit 100, compared with a configuration omitting the compensation circuit 130. In some embodiments, the compensation circuit 130 causes the phase margin of the voltage regulator circuit 100 to be equal to or greater than 30 degrees. In at least one embodiment, the compensation circuit 130 causes the phase margin of the voltage regulator circuit 100 to range from 45 degrees to 90 degrees.

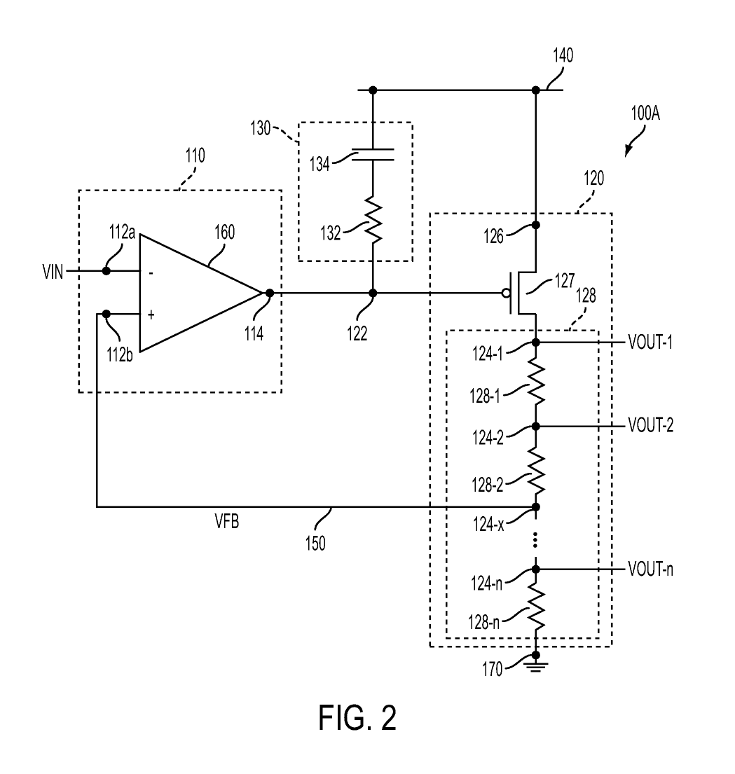

FIG. 2 is a circuit diagram of an example voltage regulator 100A in accordance with one or more embodiments. As depicted in FIG. 2, the input stage circuit 110 includes an amplifier 160, such as a single-stage differential amplifier, a multiple-stage amplifier, or an operational amplifier. The first input 112a is coupled to a negative input terminal of the amplifier 160, and the second input 112b is coupled to a positive input terminal of the amplifier 160. The negative input terminal of the amplifier 160 receives the input signal VIN, and the positive input terminal of the amplifier 160 receives the feedback signal VFB from output stage circuit 120. The output 114 of the first stage circuit 110 is coupled to an output terminal of the amplifier 160.

The output stage circuit 120 includes a transistor 127 and a resistance device 128. The transistor 127 has a gate terminal, a drain terminal, and a source terminal. The gate terminal of the transistor 127 is coupled to the input 122 of the second stage circuit 120. The source terminal of the transistor 127 is coupled to a power node 126, and a drain terminal of the transistor 127 is coupled to the resistance device 128. The resistance device 128 is coupled between the drain terminal of the transistor 127 and another power supply line 170, which is in turn coupled to another power supply for providing a supply voltage, such as a negative voltage power supply VSS or ground GND. The transistor 127 and the resistance device 128 are connected as a common-source amplifier.

In some embodiments, transistor 127 is a p-type metal-oxide semiconductor field effect transistor (PMOS transistor). The resistance device 128 is a resistance ladder including n resistors 128-1, 128-2, . . . , 128-n connected in series between the drain terminal of transistor 127 and the power supply line 170. The one or more outputs 124-1, 124-2, . . . , 124-n are nodes between adjacent ones of the resistors 128-1, 128-2, . . . , 128-n or between the resistor 128-1 and the transistor 127. The output signals VOUT-1, . . . , VOUT-n of the voltage regulator 100 are taken from corresponding outputs 124-1, 124-2, . . . , 124-n along the resistance ladder of the resistance device 128. In at least one embodiment, the feedback path 150 is coupled to one of the outputs, such as the output denoted as output 124-x. The number “n” is a positive integer, and the number x is between 1 and n. In some embodiments, n equals 1. In some embodiments, not all outputs 124-1, 124-2, . . . , 124-n are connected with an external circuit.

The compensation circuit 130 includes a resistance device 132 and a capacitance device 134 connected in series between the power line 140 and the input 122 of the second stage circuit 120 or the output 114 of the input stage circuit 110. In some embodiments, the resistance device 132 is a resistor or a transistor biased as a resistor. In some embodiments, the capacitance device 134 is a capacitor or a transistor configured as a capacitor. In some embodiments, the resistance device 132 is directly coupled to the input 122 of the second stage circuit 120, and the capacitor device 134 is coupled to the power supply line 140. In some embodiments, the capacitance device 134 is directly coupled to the input 122 of the second stage circuit 120, and the resistance device 132 is coupled to the power supply line 140. In some embodiments, the compensation circuit 130 includes other electrical components, such as one or more inductors, capacitors, and resistors in addition to the resistance device 132 and the capacitance device 134.

The compensation circuit 130 is usable to adjust a biasing voltage of the input 122 of the output stage circuit 120 in response to a voltage level of the power supply line 140. In some embodiments, the compensation circuit 130 is set to transmit a voltage fluctuation at the power supply line 140 to the input 122 of the output stage circuit 120. In some embodiments where the output stage circuit 120 has a transistor 127 connected as a common-source amplifier, the compensation circuit 130 is set to maintain a gate-to-source biasing voltage of the transistor 127 of the output stage circuit 120. Therefore, noise at the power supply line 140 is also coupled to the input 122 of the output stage circuit 120 via the compensation circuit 130, and thus an impact to a biasing condition of the output stage circuit is canceled or deemphasized. Therefore, the compensation circuit 130 improves the PSRR performance of the output stage circuit 120 and is also referred to in the present application as a PSRR boost circuit 130.

Additionally, the compensation circuit 130 is usable to stabilize the voltage regulator 100. For performing frequency response and stability analysis of a circuit, a frequency-domain transfer function is used. The frequency-domain transfer function is usually a function of frequency arranged to have a denominator component and a numerator component. The solutions for the denominator component are referred to as “poles,” and the solutions at the numerator component are referred to as “zeros.” In some embodiments, the compensation circuit 130 and the input stage circuit 110 are configured to have a lowest-frequency pole (i.e., a dominant pole, the pole that has the lowest frequency among all the pole(s)), in a frequency-domain transfer function representing a combination of the compensation circuit 130 and the input stage circuit 110, at a frequency lower than that of the input stage circuit 110 alone.

In some embodiments, the frequency of the lowest-frequency pole of the combination of the compensation circuit 130 and the input stage circuit 110 is determined by setting the voltage regulator 100 to have a phase margin greater than a predetermined value, such as 30 degrees. In some embodiments, the lowest-frequency pole of the combination of the compensation circuit 130 and the input stage circuit 110 is set by setting the resistance value of the resistance device 132 and/or the capacitance value of the capacitance device 134. In some embodiments, the frequency of the lowest-frequency pole of the combination of the compensation circuit 130 and the input stage circuit 110 is equal to or less than 10 kHz.

In some embodiments, the lowest-frequency pole (i.e., dominant pole) of the voltage regulator 100 is primarily contributed by the input stage circuit 110. In some embodiments, the lowest-frequency pole of the voltage regulator 100 is primarily contributed by the second stage circuit 120. In some embodiments, the effects of the compensation circuit 130, from a perspective of a frequency-domain analysis of the transfer function of the input stage circuit 110, includes shifting the lowest-frequency pole of the input stage circuit 110 to a frequency lower than that of the input stage circuit 110 alone. In some embodiments, the effects of the compensation circuit 130, from a perspective of a frequency-domain analysis of the transfer function of the voltage regulator 100, includes shifting the lowest-frequency pole of the voltage regulator 100 to a frequency lower than that of a configuration of the voltage regulator where the compensation circuit 130 is omitted.

In some embodiments, the compensation circuit 130 is configured to have a zero, in a frequency-domain transfer function representing the compensation circuit and the output stage circuit 120, sufficient to compensate for a lowest-frequency pole in a transfer function representing the output stage circuit. In some embodiments, the compensation of the lowest-frequency pole of the output stage circuit 120 causes the voltage regulator 100 to have a predetermined phase margin and/or improves the stability of the voltage regulator. In some embodiments, the lowest-frequency pole of the output stage circuit 120 is the lowest-frequency pole of the overall voltage regulator 100. In some embodiments, the zero of the compensation circuit 130 is set to match the frequency of the lowest-frequency pole in the transfer function representing the output stage circuit 120 by setting the resistance value of the resistance device 132 and/or the capacitance value of the capacitance device 134. In some embodiments, the lowest-frequency pole of the output stage circuit 120 is higher than that of the lowest-frequency pole of the input stage circuit 110, and the zero of the compensation circuit 130 is higher than the lowest-frequency pole of the input stage circuit 110 and closer to the lowest-frequency pole of the output stage circuit 120 than that of the input stage circuit 110. Thus, having the zero closer to the lowest-frequency pole of the output stage circuit 120 causes the voltage regulator 100 to meet a predetermined phase margin and/or improves the stability of the voltage regulator.

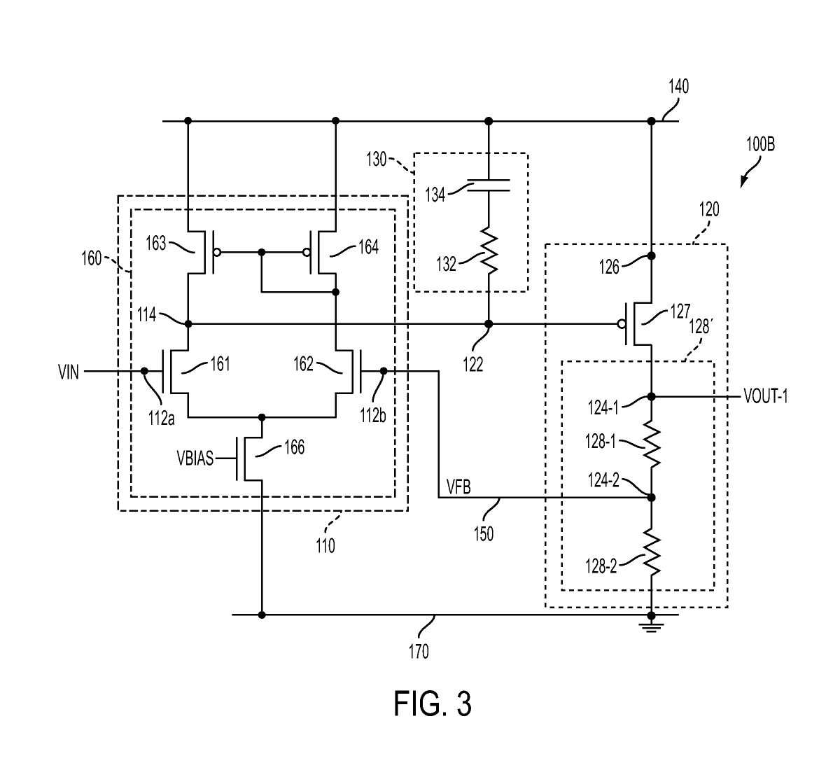

FIG. 3 is a circuit diagram of another example voltage regulator 100B in accordance with one or more embodiments. Compared with the voltage regulator 100A depicted in FIG. 2, the resistance device 128′ in the voltage regulator 100B depicted in FIG. 3 has only two resistors 128-1 and 128-2. One output 124-1 of the output stage circuit 120 is for outputting an output signal VOUT-1, and another output 124-2 of the output stage circuit 120 is coupled to the feedback path 150 for outputting the feedback signal VFB to the second input 112b of the input stage circuit 110. In some embodiments, the resistance device 128′ has more than two resistors 128-1 and 128-2. In at least one embodiment, the resistance device 128′ has only one resistor between the transistor 127 and the power supply line 170, the resistor 128-2, for example, is omitted, and the feedback path is coupled to the output 124-1.

As depicted in FIG. 3, the amplifier 160 is a single-stage differential amplifier. The amplifier 160 includes a first transistor 161, a second transistor 162, a third transistor 163, a fourth transistor 164, and a fifth transistor 166. Each of the first transistor 161, the second transistor 162, the third transistor 163, the fourth transistor 164, and the fifth transistor 166 has a gate terminal, a source terminal, and a drain terminal. In some embodiments, the first transistor 161, the second transistor 162, and the fifth transistor 166 are n-type metal-oxide semiconductor field effect transistors (NMOS transistors), and the third transistor and the fourth transistor are PMOS transistors.

The first transistor 161 and the second transistor 162 are arranged as a pair of common-source amplifiers. The gate terminal of the first transistor 161 coupled to the first input 112a, the gate terminal of the second transistor 162 coupled to the second input 112b, and the source terminals of the first transistor 161 and the second transistor 162 are coupled together working as a virtual ground node. The third transistor 163 and the fourth transistor 164 are arranged as a current-mirror load for the first transistor 161 and the second transistor 162 in order to convert differential signals at the first input 112a and the second input 112b to a single-ended output signal at the output 114. The source terminals of the third transistor 163 and the fourth transistor 164 are coupled to the power supply line 140, and the gate terminals of the third transistor 163 and the fourth transistor 164 are coupled together. The drain terminal of the third transistor 163 is coupled to the output 114 and the drain terminal of the first transistor 161, and the drain terminal of the fourth transistor 164 is coupled to the gate terminal of the fourth transistor 164 and the drain terminal of the second transistor 162.

The source terminal of the fifth transistor 166 is coupled to the power supply line 170, the drain terminal of the fifth transistor 166 is coupled to the source terminals of the first transistor 161 and the second transistor 162. The gate terminal of the fifth transistor 166 receives a bias signal VBIAS. The fifth transistor 166 acts as a current source for the differential pair formed by the first transistor 161 and the second transistor 162, and the bias signal VBIAS controls an amount of current through the fifth transistor 166. In some embodiments, the amplifier 160 has a variety of configurations or architectures similar or different to the configuration depicted in FIG. 3.

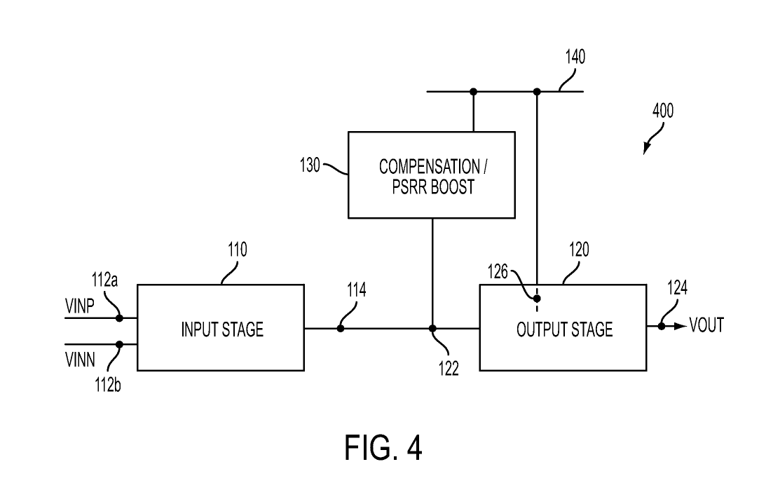

FIG. 4 is a block diagram of an amplification circuit 400 in accordance with one or more embodiments. Compared with the block diagram of the voltage regulator 100 depicted in FIG. 1, the feedback path 150 (FIG. 1) is omitted, the first input 112a of the input stage circuit 110 receives a positive input signal VINP (with respect to an output signal VOUT at the output 124), and the second input 112b of the input stage circuit receives a negative input signal VINN. The output stage circuit 120 has only one output 124 outputting the output signal VOUT. In some embodiments, the output stage circuit 120 has two or more outputs. In some embodiments, the input stage circuit 110 and the output stage circuit 120 are amplifiers. In some embodiments, the configuration and operation of the input stage circuit 110 (i.e., a first amplifier), the output stage circuit 120 (i.e., a second amplifier), and the compensation circuit 130 (i.e., a PSRR boost circuit) are the same or similar to those depicted in FIGS. 1-3, and thus the description for the input stage circuit 110, the output stage circuit 120, and the compensation circuit 130 is not repeated.

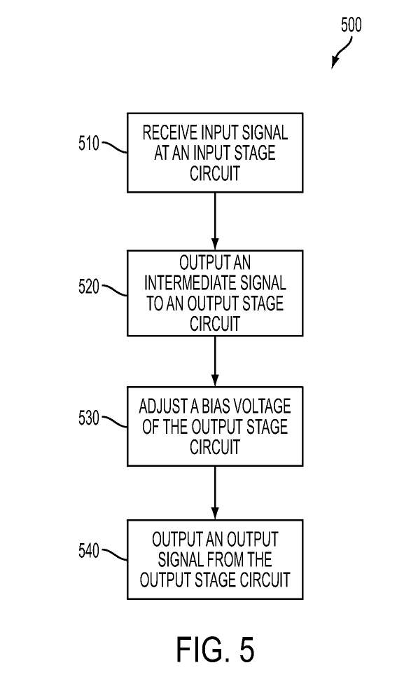

FIG. 5 is flowchart of a method 500 of operating an amplification circuit or a voltage regulator in accordance with one or more embodiments. It is understood that additional operations may be performed before, during, and/or after the method 500 depicted in FIG. 5, and that some other operations may only be briefly described herein.

As depicted in FIG. 5 and FIGS. 1-4, in operation 510, an input stage circuit 110 receives one or more input signals VIN, VFB, VINP, and/or VINN. Then, in operation 520, an intermediate signal is output from the input stage circuit 110 in response to the one or more input signals VIN, VFB, VINP, and/or VINN to an input 122 of the output stage circuit 120. In some embodiments where the input stage circuit 110 includes a differential amplifier, when the input signal VIN/VINP is greater than the input signal VFB/VINN, a voltage level of the intermediate signal decreases, and when in the input voltage VIN/VINP is less than the input signal VFB/VINN, the voltage level of the intermediate signal increases.

As depicted in FIG. 5 and FIGS. 1-4, in operation 530, a compensation circuit 130 adjusts a biasing voltage of the input 122 of the output stage circuit 120 in response to a voltage level of a power supply line 140. The output stage circuit 120 is coupled to the power supply line 140, and the compensation circuit 130 is coupled between the input 122 of the output stage circuit 120 and the power supply line 140.

In some embodiments, the compensation circuit 130 includes a resistance device 132 and a capacitance device 134 connected in series between the power supply line 140 and the input 122 of the output stage circuit 120. In some embodiments, the compensation circuit 130 adjusts the biasing voltage of the input 122 of the output stage circuit 120 by transmitting a voltage fluctuation at the power supply line 140 to the input 122 of the output stage circuit 120. In some embodiments, the output stage circuit 120 comprises a transistor 127 having a source terminal coupled to the power supply line 140 and a gate terminal coupled to the input 122 of the output stage circuit 120, and the transistor 127 is arranged as a common-source amplifier. In some embodiments, the compensation circuit 130 adjusts the biasing voltage of the input 122 of the output stage circuit 120 by maintaining a gate-to-source biasing voltage of the transistor 127 of the output stage circuit 120.

As depicted in FIG. 5 and FIGS. 1-4, in operation 540, one or more output signals VOUT or VOUT-1˜VOUT-n are output from the output stage circuit 120. In some embodiments when operating a voltage regulator 100, 100A, or 100B, a feedback signal VFB is generated by the output stage circuit 120, and the feedback signal VFB is passed to the input stage circuit 110 along a feedback path 150.

In accordance with one embodiment, a voltage regulator circuit includes an input stage circuit, an output stage circuit, and a compensation circuit. The input stage circuit has a first input configured to receive an input signal, a second input configured to receive a feedback signal, and an output. The output stage circuit has an input coupled to the output of the input stage circuit, a power node coupled to a first power supply, and one or more outputs. At least one of the one or more outputs of the output stage circuit is coupled to the second input of the input stage circuit. The compensation circuit is coupled between the input of the output stage circuit and the first power supply, and the compensation circuit is configured to increase a phase margin of the voltage regulator circuit.

In accordance with another embodiment, a method includes outputting an intermediate signal from an input stage circuit in response to an input signal received by the input stage circuit to an input of an output stage circuit. The output stage circuit is coupled to a power supply, and a compensation circuit is coupled between the input of the output stage circuit and the power supply. The compensation circuit adjusts a biasing voltage of the input of the output stage circuit in response to a voltage level of the power supply. An output signal is output from the output stage circuit.

In accordance with yet another embodiment, an amplification circuit includes a first amplifier, a second amplifier, and a power supply rejection ratio (PSRR) boost circuit. The first amplifier has an output. The second amplifier has an input coupled to the output of the first amplifier and a power node coupled to a power supply line. The PSRR boost circuit is coupled between the input of the second amplifier and the power supply line, and the PSRR boost circuit comprises a resistance device and a capacitance device connected in series with the resistance device.

The foregoing outlines features of several embodiments so that those of ordinary skill in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A voltage regulator circuit, comprising:
a first power supply line;
an input stage circuit having a first input configured to receive an input signal, a second input configured to receive a feedback signal, and an output;
an output stage circuit having an input coupled to the output of the input stage circuit, a power node coupled to the first power supply line, and one or more outputs, at least one of the one or more outputs of the output stage circuit coupled to the second input of the input stage circuit; and
a compensation circuit coupled between the input of the output stage circuit and the first power supply line, the compensation circuit configured to increase a phase margin of the voltage regulator circuit.

2. The voltage regulator circuit of claim 1, wherein the compensation circuit is configured to cause a power supply rejection ratio (PSRR) of the output stage circuit to be equal to or greater than 80 dB within a predetermined frequency band.

3. The voltage regulator circuit of claim 2, wherein the predetermined frequency band ranges from 0 to 10 kHz.

4. The voltage regulator circuit of claim 1, wherein the compensation circuit and the input stage circuit are configured to have a lowest-frequency pole, in a transfer function representing a combination of the compensation circuit and the input stage circuit, at a frequency lower than that of the input stage circuit alone.

5. The voltage regulator circuit of claim 1, wherein the compensation circuit is configured to have a zero, in a transfer function representing a combination of the compensation circuit and the output stage circuit, sufficient to compensate for a lowest-frequency pole in a transfer function representing the output stage circuit.

6. The voltage regulator circuit of claim 1, wherein the compensation circuit comprises a resistance device and a capacitance device connected in series between the first power supply line and the input of the second stage circuit.

7. The voltage regulator of claim 1, wherein the input stage circuit comprises a differential amplifier.

8. The voltage regulator of claim 1, further comprising a second power supply line, wherein the output stage circuit comprises:
a transistor having a gate coupled to the input of the output stage circuit and a source coupled to the first power supply line; and
a resistance ladder coupled between a drain of the transistor and the second power supply line configured to have a voltage level different from a voltage level of the first power supply line.

9. The voltage regulator of claim 8, wherein the input stage circuit is coupled to a node between two resistors of the resistance ladder.

10. The voltage regulator of claim 9, wherein the second input of the input stage circuit comprises a differential amplifier.

11. A method, comprising:
outputting an intermediate signal from an input stage circuit in response to an input signal received by the input stage circuit to an input of an output stage circuit, the output stage circuit coupled to a power supply line, and a compensation circuit coupled between the input of the output stage circuit and the power supply line;
adjusting, by the compensation circuit, a biasing voltage of the input of the output stage circuit in response to a voltage level of the power supply line; and
outputting an output signal from the output stage circuit.

12. The method of claim 11, wherein the compensation circuit comprises a resistance device and a capacitance device connected in series between the input of the output stage circuit and the power supply line, and the adjusting the biasing voltage of the input of the output stage circuit comprises transmitting a voltage fluctuation at the power supply line to the input of the output stage circuit.

13. The method of claim 11, wherein the output stage circuit comprises a transistor having a source terminal coupled to the power supply and a gate terminal coupled to the input of the output stage circuit, the transistor is arranged as a common-source amplifier, and the adjusting the biasing voltage of the input of the output stage circuit comprises maintaining a gate-to-source biasing voltage of the transistor of the output stage circuit.

14. The method of claim 11, further comprising:
generating a feedback signal by the output stage circuit; and
passing the feedback signal to the input stage circuit along a feedback path.

15. An amplification circuit, comprising:
a power supply line;
a first amplifier having an output;
a second amplifier having an input coupled to the output of the first amplifier and a power node coupled to the power supply; and
a power supply rejection ratio (PSRR) boost circuit coupled between the input of the second amplifier and the power supply line, the PSRR boost circuit comprising a resistance device and a capacitance device connected in series between the input of the second amplifier and the power supply line.

16. The amplification circuit of claim 15, wherein the PSRR boost circuit is configured to cause a PSRR of the second amplifier circuit to be equal to or greater than 80 dB within a predetermined frequency band.

17. The amplification circuit of claim 15, wherein a combination of the PSRR boost circuit and the first amplifier is configured to have a lowest-frequency pole, in a transfer function representing a combination of the PSRR boost circuit and the first amplifier, at a frequency lower than that of the first amplifier alone.

18. The amplification circuit of claim 15, wherein the PSRR boost circuit is configured to have a zero, in a transfer function representing a combination of the PSRR boost circuit and the second amplifier, sufficient to compensate for a lowest-frequency pole in a transfer function representing the second amplifier.

19. The amplification circuit of claim 15, wherein the first amplifier comprises a differential amplifier.

20. The amplification circuit of claim 15, wherein the second amplifier comprises a transistor having a source terminal coupled to the power supply line and a gate terminal coupled to the input of the second amplifier, and the transistor is arranged as a common-source amplifier.
